(19) United States
(12) Patent Application Publication
(10) Pub. No.: US 2007/0033156 A1
(43) Pub. Date: Feb. 8, 2007

(54) System for managing digital assets

(75) Inventors: Jacqueline Lee Limpert, Menasha, WI (US); Kim Marie Greenwood, Appleton, WI (US); James Michael McPartlin, Appleton, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 11/196,861

(22) Filed: Aug. 4, 2005

(51) Int. Cl. G06F 17/30; G06F 15/16

(52) U.S. Cl. 707/1; 709/217

(57) ABSTRACT

A system for managing digital assets is disclosed which includes having a first source capable of creating a designated stock code for an item and having a second source capable of developing a digital asset for each of the items. The system also includes a central repository capable of receiving, storing and disseminating the designated stock codes and the corresponding digital assets for each item. A third source is utilized which is capable of identifying items ordered by a party and matching the items to at least one of the corresponding digital assets. The system further includes a medium for providing access to the central repository or conveying or pushing the digital assets to the designated party.

### BACKGROUND OF THE INVENTION

Today, many individuals, public and private businesses, government agencies, legal and non-legal entities, etc., design, create, develop, establish, store, retain, provide access to, convey and/or disseminate information to others as digital assets. Digital assets can include but are not limited to: electronic text files, image files, numeric files, photo files, graphic files, packaging display files, media image files, visual files, video files, video clips, audio files, audio recordings, movies, programs, software programs, electronic programs, spreadsheets, computer databases, etc. Many times, such digital assets are created by one or more people within an organization and are then shared or made accessible to other people within the organization or to people external to the organization. For example, the design department of a corporation, that markets branded, generic or private label consumer products, can create a package appearance for a particular product that includes graphics, designs, symbols, icons, trademarks, photos, visual images and/or printed information that informs the buyer of exactly what kind of products are contained within the package. The graphical, colored and/or visual display on the package can catch the eye of the consumer and cause their attention to be drawn to the package. The package's overall shape and design can assist in causing the consumer to focus on a particular package. The overall appearance of the package can include written information in the form of letters, words, numbers, symbols, icons, trademarks, photos, cartoon characters, etc. Instructions can be displayed on the package to indicate how the product should be used, how the product functions or when to use such product. Safety information can also be included on the package to inform the consumer of any danger with using or disposing of the product.

Frequently, the package appearance is altered, modified, updated, or changed to reflect changes to the products themselves or to provide a different overall appearance or color change to the package. The package appearance can also be changed or updated to advertise a sales promotion, to alert the consumer that the product has been improved or that the price has been changed. For these as well as other reasons, the appearance of a package can occur very frequently. This is especially true when there is fierce competition between manufacturers of similar products or when consumer products are involved, which keep being redesigned to make them new and improved.

It is customary for many manufacturers to produce or have produced print ads, like magazine ads, newspaper ads, flyers, etc., as well as TV and/or radio advertisements to promote their products to the ultimate consumer. It is important that such advertisements include the latest package appearance and graphics to prevent the consumer from becoming confused when he or she is at a store trying to locate and buy the product. For example, if an advertisement for a feminine care product depicts a plastic film package having a red flower mounted on a white background, when in fact the product is packaged in a blue package that does not contain a flower, the consumer may be unable to locate the product on the store's shelf. This could result in a lost sale. Even worse, the consumer may permanently switch to a competitor's brand that is more prominently displayed.

In addition to a manufacturer doing general advertising, many external vendors, such as a retailer, distributor or middle man, will also promote particular products in their local markets. Because of this, they need the most recent package appearance and graphics so as to produce or have produced for them, sales and/or promotional advertisement. Such local promotions can cause the products to be quickly purchased by their customers. For example, a retailer like Wal-Mart, Target, ShopKo, Walgreen, etc., normally will commission to have the local newspapers print inserts which advertise specials on certain products. The specially advertised product may be priced more favorably than similar products sold by their competitors.

Therefore, there is a real need for manufacturers to be able to share, provide access to and/or make available to both internal and external parties their latest package appearance and graphics. It is especially beneficial for a manufacturer to be able to prevent out of date or stale package appearances and graphics from being accessible by the internal and external parties, advertising agencies, etc. It is equally as important for a manufacturer to know that his most recent changes to his package appearance and graphics are being reflected in the latest promotional advertisements.

Now a system has been invented for managing packaging appearances and graphics, retained as digital assets in a central repository, so that such information can be integrated with order processing systems and be converted and pushed to internal as well as external parties. The system also enables such digital assets to be formatted to be compatible with the receiving party's hardware and software.

### SUMMARY OF THE INVENTION

Briefly, this invention relates to a system for managing digital assets. The system includes a first source capable of creating a designated stock code for a product or item and having a second source capable of developing a digital asset for each of the products or items. The system also includes a central repository capable of receiving, storing and disseminating the designated stock codes and the corresponding digital assets for each of the products or items. A third source is utilized which is capable of identifying products or items ordered by a party and matching the products or items to at least one of the designated stock codes and/or to at least one of the corresponding digital assets. The system further includes a medium for providing access to or conveying the information in the central repository to the ordering party or a second party identified by the ordering party. The system is also capable of archiving the information received or conveyed to the ordering party so that a history of such transactions can be obtained.

### BRIEF DESCRIPTION OF THE DRAWINGS

FIG. 1 is a flowchart showing a system for managing digital assets where an ordering party is allowed access to the digital assets.

FIG. 2 is a flowchart showing an alternative embodiment of a system for managing digital assets where the digital assets are conveyed to the ordering party.

FIG. 3 is a flowchart showing still another embodiment of a system for managing digital assets where the ordering party identifies another party to receive the digital assets.

### DETAILED DESCRIPTION

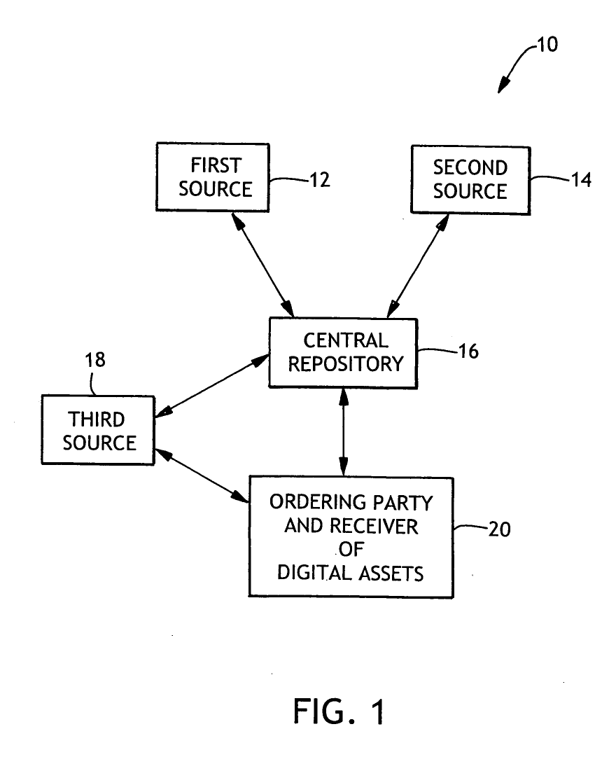

Referring to FIG. 1, a flowchart is depicted showing a system 10 for managing digital assets. The system 10 can be employed by an individual, a public business, a private business, a government agency,. a legal or non-legal entity or any other establishment who has a need to receive, store and/or disseminate information. The system 10 manages digital assets. Digital assets can include but are not limited to: electronic files, computer files, text files, image files, numeric files, photo files, graphic files, packaging display files, media image files, visual files, video files, video clips, audio files, audio recordings, movies, programs, software programs, programs stored on CD's, DVD's, VCR's, electronic programs, spreadsheets, computer databases, etc. It should be recognized that “digital assets” may also include other forms, representations and mediums for receiving, storing and/or disseminating information.

Digital assets can be created, designed, developed or formulated by one or more persons. The creators can work for a single entity or work at two or more different entities. Once such digital assets are created and/or stored, they can then be shared or made accessible to other people, including people within a single organization or with people who are external to that particular organization. For example, a manufacturer of a product, especially a consumer product, may have a design department which creates the display and images on their packages. A particular package will have a unique package appearance that may include graphics, visual images, designs, trademarks, icons, photos, a printed description and color which identifies that the products are coming from a certain manufacturer. For example, a box of facial tissue bearing the name “KLEENEX” is only available from Kimberly-Clark Corporation. KLEENEX is a registered trademark of Kimberly-Clark Corporation, having an office at 401 North Lake Street, Neenah, Wis. 54956. Alternatively, the manufacturer may employ an independent design agency to create the package appearance and graphics. In either case, the unique package appearance and graphics must be created, retained, stored and then ultimately shared or disseminated to others.

In the first scenario presented above, the manufacturer's design department will need to share the package appearance and graphics with a distributor, middle man or retailer of the product. Many times, a distributor or middle man who is in the business of reselling the product, for example to multiple retailers, will have a need to promote and/or advertise the product. This is done to ensure that a sufficient quantity of the product is sold such that the distributor or middle man can make a reasonable profit. Furthermore, when the manufacturer sells directly to a retailer, especially a large retailer such as to Wal-Mart, Target, ShopKo, Walgreen, etc., who is going to market the product to the ultimate consumer, the retailer will normally need to receive an image of the package appearance and graphics. The retailer will require such information so that they can create, or have created for them, an advertisement which will appear in a local or regional area. Such promotional advertisement can take the form of television ads, radio ads, newspaper ads, inserts to newspapers, flyers, end of aisle displays, promotional banners, window displays, etc. Like the distributor or middle man, the retailer also wants to sell as much product as possible to increase his profits.

In the alternative scenario presented above, the independent design agency will need to deliver, send or convey the final package appearance and graphics back to the manufacturer to receive his approval and then may be asked to forward such information to a third party who will actually produce the packages, or forward the package appearance and graphics to a distributor, middle man or retailer who needs the information for the reason described above.

It should be apparent that the manufacturer, the distributor, middle man, and/or retailer, all have a desire to make sure that they have the latest and correct image of the package appearance and graphics so that they are properly advertising the most recent design. For example, if the manufacturer is conducting a national rollout or launch of a new or improved product with television advertisement, and one or more retailers are also supporting the launch with local print advertisement, it is imperative that both advertisement mediums depict the same package. This is especially true for special selling promotions where a single size package is advertised at a reduced cost compared to its regular everyday price. The synergism accomplished by advertising in multiple mediums by the manufacturer and the retailer can assure a favorable outcome to both parties with the result being increased revenue. In addition, by using the same and similar package appearance and graphics in all the promotion and advertising mediums, confusion in the marketplace can be avoided. Both the manufacturer and the retailer want to make sure that when the ultimate consumer goes into the store to purchase the desired product that he or she will quickly recognize the package and purchase the correct brand and size of package that may be advertised at a special price.

Again referring to FIG. 1, the system 10 includes a first source 12 which is capable of creating a designated stock code for a particular product or item. The first source 12 can be one or more persons within a department of an organization or a machine that generates, creates or establishes a designated stock code for a product or item. For example, the first source 12 can consist of an electronic file or a software program that is capable of electronically generating a designated stock code. In a large consumer product company that sells branded, generic and/or private label products, such as Kimberly-Clark Corporation, the packaging department usually specifies a stock code for all new or improved products.

A “stock code” is defined as a predetermined system of symbols, letters, numbers, or words given certain arbitrary meaning and used to convey information about a particular product. The “stock code” can contain alphabetical, numerical, alphanumeric symbols, punctuation marks, mathematical symbols, and other conventional symbols, marks or nomenclature known to those skilled in the packaging art.

The system 10 also includes a second source 14 which is capable of developing a digital asset for package appearance and graphics for each particular product or item. The second source 14 can also be the first source 12 but usually is not. Normally, the second source 14 includes one or more persons having unique artistic talents that allow them to create and design graphics, visual images, videos, audio clips, etc., for the package in which the products or items will be contained or covered. It should be noted that some products are of such size or shape that they are not contained within a package but may be protected by a cover or sheet which has graphics or images printed thereon.

For the purpose of this invention, the digital asset can be the package appearance and can include all information relating to the size, shape, overall appearance, background color, other coloring, material from which the package is constructed, graphics, letter(s), words and numbers appearing in print form, trademarks, icons, symbols, etc., that appear on the package itself. All such information, as well as any other information known to those skilled in the packaging art, can be captured and classified as part of the digital assets of the manufacturer. For example, art work printed onto a plastic bag formed from a flexible polyethylene material can create a different image and appearance than the same art work printed onto a cardboard box. In this instance, the material from which the package is formed and the method used to print or apply the art work is considered to be part of the digital assets.

Kimberly-Clark Corporation manufactures and sells a variety of branded, generic and private label disposable consumer products, such as infant diapers, sanitary napkins, pantyliners, tampons, child training pants, adult incontinent briefs, guards and undergarments, menstrual panties, paper towels, toilet paper, wet wipes, facial tissue, napkins, etc. Most of these products are reengineered, improved upon or updated on a regular basis and, when this occurs, the package appearance and graphics are normally changed, modified or altered to reflect the improvement to the product contained within the package. Alternatively, the appearance of the package itself can be changed or modified to give it a new look or make it easier to recognize. The package appearance and graphics function to alert and provide notice to the ultimate consumer of the change to the product. The package appearance can also present the product in a more appealing format to help it sell better.

Whenever new digital assets are created, they have to be sent to, received and stored in some electronic, computer, manual, encrypted or other known form such that they can be quickly, efficiently and accurately retrieved. In the present system 10, a central repository 16 is employed which is capable of receiving, storing and disseminating the designated stock codes and the corresponding digital assets for each package containing the products or items to be sold. The central repository 16 can be thought of as a library, for example an electronic or computerized library, where information can be placed for safe keeping. The central repository 16 can retain the information in any medium known to those skilled in the storage and retrieval art. It should also be evident that the digital assets can be stored in one medium and be retrieved in a second medium. For example, the digital assets can be stored electronically but be retrieved manually. Desirably, the digital assets will be received, stored and disseminated using a single medium.

The information in the central repository 16, which includes but is not limited to the designated stock codes and the corresponding digital assets for each package, can be retained as a separate item or it can be combined with other information such that all of the information relating to a particular product can be retrieved simultaneous or sequentially, depending upon the preference of the recipient. For example, for a given product, one could retrieve the stock code separate from the corresponding digital assets.

The system 10 further includes a third source 18 which is capable of identifying products or items ordered by a party 20 and matching the ordered products or items to at least one of the corresponding digital assets. The third source 18 can again be a person or persons within a department of an organization that is set up to receive incoming orders. Alternatively, the third source 18 can consist of an electronic file or a software program that is capable of receiving incoming orders for products or items. The third source 18 has to have the ability to match the ordered products or items to the corresponding digital assets. The incoming orders can be received in written or printed form, electronically, by a computer interface, using the web, telephonically, by facsimile, or in any other way known to those skilled in the art of transmitting and receiving information. The electronic file or the software program must also be capable of matching the ordered products or items to the corresponding digital assets. Like the second source 14, the third source 18 can also serve as the first source 12 and/or the second source 14 but desirably does not. The reason why the third source 18 is separate and distinct from either the first or second sources, 12 and 14 respectively, is that the third source 18 normally includes one or more persons having unique customer relation skills along with a talent in mathematics and is usually well organized, such that incoming orders are properly processed in a timely and efficient manner.

Still referring to FIG. 1, the system 10 is designed such that the ordering party 20 is permitted and allowed access to the central repository 16. The ordering party 20 can also be given online access. Furthermore, the ordering party 20 can have the digital assets pushed to him. The ordering party 20 is normally an external party, such as a distributor, middle man, or an external vendor or retailer, who is ordering the products or items from a manufacturer for the general purpose of reselling them. The external party 20 may sell the products or items directly to the ultimate consumer or may serve as an intermediary between the manufacturer and one or more retailers. Alternatively, the ordering party 20 may be an internal person, department or entity of the manufacturer, for example a wholly owned subsidiary, that is ordering the products or items for its own use, to assemble the products into subassemblies or to incorporate the products or items into a new or more complicated end product. As mentioned above, the ordering party 20 may have a need to create, design, produce or have produced for it promotional advertisement to assist in marketing the ordered products or items. In order to assure that the ordering party 20 has the latest visual and graphical images, the ordering party 20 can tap into the central repository 16 twenty-four hours a day, seven days a week. This assures that the ordering party 20 has the ability to obtain the latest digital assets for the current rendition of the package appearance and graphics. The ordering party 20 can also check or cross check his orders against the designated stock codes for a particular product or item. Furthermore, the ordering party 20 can check or cross check a single ordered product or item, or check or cross check any portion of his order, including his entire order, if desired.

The ordering party 20 can receive the digital assets from the central repository 16 in any desired form that is compatible with his internal equipment, hardware, software or software programs. A person, machine, Internet uploading service, video camera, etc., can serve as the source of images which are then provided in electronic format. For example, the ordering party 20 can receive the digital assets manually, electronically, by facsimile, by telephone, by a computer interface, etc. Another example is where the digital assets are graphical images which the ordering party 20 can download from his computer system and print the images on a tangible medium such as white paper, color paper, paperboard, cardboard, plastic or any other kind of display material.

The system 10 is constructed and programmed such that the ordering party 20 can receive digital assets that correspond to his ordered products or items but will be unable to obtain information relative to non-ordered products or items. This security measure ensures that digital assets covering products or items made up into special trial pack, a special jumbo pack or a one of a kind package, specifically created for another retailer and/or priced in a particular way, can not be obtained by parties not involved in such orders. The means or mechanism for allowing the ordering party 20 access to the central repository 16 can be customized by a software engineer or computer specialist such that the available digital assets correspond to only his ordered products or items.

In addition, the party that controls the central repository 16 can receive, store and archive each inquiry made by an ordering party 20 and can retain such inquiries for future auditing. The controlling party can then archive such information in a database regarding each digital asset that has been conveyed, pushed or retrieved by an ordering party and further link such information to a corresponding product to be marketed by the controlling party. Also, the controlling party can verify receipts by the ordering party 20 as part of the archiving process.

Furthermore, the system 10 can be integrated with Enterprise Resource Planning (ERP) software systems such as SAP, available from SAP America, Inc., thus allowing business plans, promotion plans, sales, customer relationship information, etc., to be linked to data pertaining to the digital assets and their use. Information about sales to or through a new customer or ordering party 20, for example, can be automatically linked to the central repository 16. The system 10 can also track an initial agreement relating to selling a new product to or through a customer or ordering party 20. Furthermore, the system 10 can authorize a customer or ordering party 20 to obtain digital assets pertaining to a new product, provide a customer or ordering party 20 with the option of automatically receiving the digital assets, or download the digital assets associated with a particular sale of the new product.

The system 10 can also be modified to provide the ordering party 20 with a receipt verifying exactly which digital files have been accessed or received.

Another variation of the system 10 is to enter into an agreement with a third party repository that could be used and adapted to take the place of the central repository 16. Currently, there are a number of privately or publicly held companies that have servers and/or exchanges that can function similar to the central repository 16. Some such exchanges include: the Uniform Code Counsel (UCCnet), Kwikee Customer Service (kwikeesupport@kwikeesystems.com), Transora (a privately held company having an office at 10 South Riverside Plaza, Suite 2000, Chicago, Ill. 60606), World Wide Retail Exchange (WWRE having an office at 625 North Washington Street, Alexandria, Va. 22314), and ECCnet in Canada (www.fcpmc.com/issues/eccnet)—Food & Consumer Products of Canada, having an office at 885 Don Mills Road, Suite 301, Toronto, Canada M3C 1V9. Since many such systems may not be secure, one could implement appropriate passwords and/or other security measures for enabling the correct digital assets to be conveyed or pushed to one's vendors, customers or ordering party 20.

The system 10 for managing digital assets can further be tweaked such that the designated stock codes and/or the digital assets can be conveyed, routed or be pushed to an independent exchange. The independent exchange can be set up to be capable of identifying items ordered by a party and then match the ordered items to at least one of the corresponding digital assets. The ordering party can then access the independent exchange such that the ordering party can acquire the digital assets which correspond to his ordered items. For security reasons, a password can be assigned to an ordering party such that the ordering party can access the independent exchange only by entering the appropriate password.

It should be noted that the manufacturer can develop or have developed for him an original version of the digital assets. This original version can then be updated, changed, modified, revised, improved upon, or be totally reworked at a later time. Once the original version of the digital asset for a particular product or item is updated or changed, the manufacturer can remove or block the original version such that it can no longer be accessed, received, conveyed or pushed to an ordering party 20. This feature will ensure that the ordering party 20 will have access to only the latest package appearance, graphics and price information.

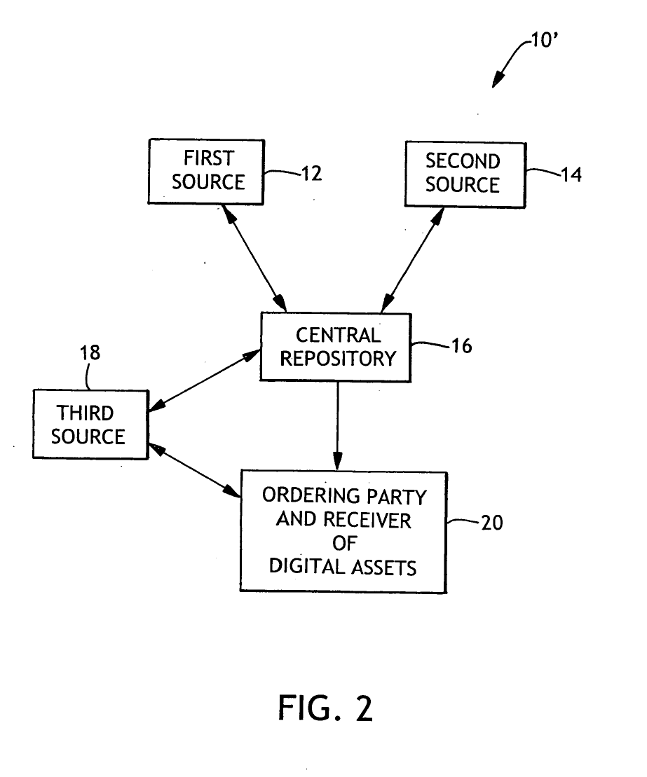

Referring now to FIG. 2, a flowchart is depicted showing an alternative system 10′ for managing digital assets. The system 10′ differs from the system 10 explained above in that the digital assets that correspond to the products or items ordered by a particular party are conveyed only to that ordering party 20. This means that the ordering party 20 is not allowed access to the central repository 16 but instead has the digital assets sent, conveyed or pushed directly to him. The digital assets can be sent, routed, conveyed, pushed or transmitted to the ordering party 20 in various forms. Such forms include: in a written or printed form, in an electronic form such as by direct transfer of files, for example, Mass Transit (MT), File Transfer Protocol (FTP), by e-mail, by a computer, using the Internet, the web, telephonically, by facsimile, by physical delivery of a computer readable medium such as a compact disk or tape, or in any other way known to those skilled in the art of transmitting and receiving information. One common way to convey the digital assets is to use a computer. The digital assets can be stored in the central repository 16 in a format which is readable by software utilized by each ordering party 20.

In FIG. 2, one will notice that the arrowed lead line from the central repository 16 shows the flow of digital assets only in one direction. The ordering party 20 is blocked from getting any digital assets out of the central repository 16. It is especially beneficial for a manufacturer to be able to prevent out of date or stale package appearances and graphics from being accessible by the ordering party 20 or by a party identified by the ordering party 20. An alternative approach to the one way flow of information is to allow the ordering party 20 to obtain such information from the central repository 16 using a verification algorithm. This will ensure that the downloaded digital assets comply with the business activities of the ordering party 20.

The digital assets can be conveyed, routed or be pushed to the ordering party 20 at any time of the day or night. For example, the manufacturer may update his digital assets at 3 p.m. central standard time and then electronically convey the digital assets to the ordering party 20 who may be located in a different time zone. Say the ordering party 20 is situated in a country in Europe that is 7 hours ahead of the time zone of the manufacturer. In this example, the ordering party 20 will receive the digital assets at 10 p.m., when his operations are shutdown or closed. The digital assets will be conveyed, routed or be pushed to each ordering party 20 in whatever form or format they desire. It should be noted that each ordering party 20 may have their own format specifications. In the morning, the employees of the ordering party 20 can open up the digital assets and download the information. The system 10′ enables the manufacturer to know that only the latest versions of his digital assets are being conveyed to the ordering party 20. In addition, the manufacturer can limit the amount of digital assets that the ordering party 20 can obtain so as to maintain control and security over his digital assets.

It should also be noted that the designated stock codes and the digital assets which correspond to the ordered products or items of an ordering party 20, can both be conveyed, routed or be pushed to the ordering party 20 prior to a time when such information is needed or required by the ordering party 20.

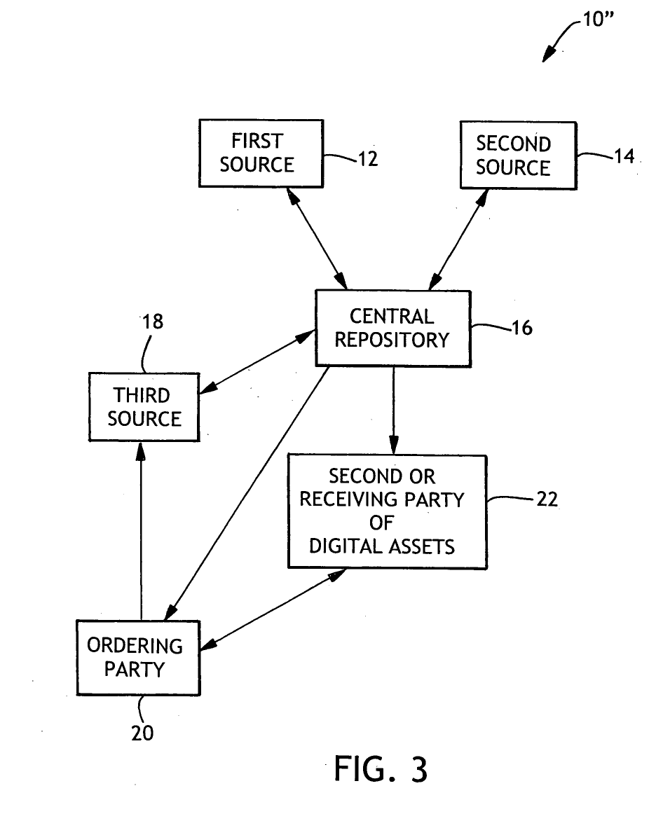

Referring now to FIG. 3, a flowchart is depicted showing still another alternative system 10″ for managing digital assets. The system 10″ differs from the two previously described systems 10 and 10′ in that the ordering party 20 identifies a second party 22 and requests the manufacturer to send the digital assets to that second party 22. The manufacturer will then convey, route or push the digital assets that correspond to the ordered products or items to the identified second party 22. For example, the second party 22 can be an advertising agency who has entered into an agreement with the ordering party 20 to create, design and/or develop promotional advertisement for the ordering party 20. In this case, the ordering party 20 does not require the digital assets but wants his advertising agency 22 to receive such digital assets so that they can perform their assigned task.

It should be noted that in FIG. 3, a connection still exists between the central repository 16 and the ordering party 20 such that certain information, for example the designated stock codes, can still be conveyed, routed or be pushed to the ordering party 20. Like the system 10′ shown in FIG. 2, the system 10″ shown in FIG. 3 provides for a secure means for assuring the manufacturer that only certain digital assets are disseminated to selected parties 20 and 22.

Lastly, although the above-identified systems 10, 10′ and 10″ have been described as a relationship between a manufacturer and an external vendor, distributor, middle man, retailer or ad agency, it should be evident to those skilled in the art that the above-identified systems 10, 10′ and 10″ for managing the digital assets can apply to other relationships and to almost any kind of transaction between two or more parties. For example, the above-identified systems 10, 10′ and 10″ for managing digital assets can be used between two or more individuals, financial institutions, banks, investment firms, stock brokers, schools, colleges, universities, government departments and agencies, private and public companies or corporations, foreign governments, etc., to transact almost any kind of business. The above-identified systems 10, 10′ and 10″ for managing digital assets can be utilized for services as well as products. Furthermore, the above-identified systems 10, 10′ and 10″ for managing digital assets can also be used between two or more parties engaged in bartering.

While the invention has been described in conjunction with several specific embodiments, it is to be understood that many alternatives, modifications and variations will be apparent to those skilled in the art in light of the aforegoing description. Accordingly, this invention is intended to embrace all such alternatives, modifications and variations that fall within the spirit and scope of the appended claims.

We claim:

1. A system for managing digital assets comprising:
a) a first source capable of creating a designated stock code for an item;
b) a second source capable of developing a digital asset for each of said items;
c) a central repository capable of receiving, storing and disseminating said designated stock codes and said corresponding digital assets for each of said items;
d) a third source capable of identifying items ordered by a party and matching said items to at least one of said corresponding digital assets; and
e) means for allowing said party access to said central repository such that said party can acquire said digital assets which correspond to said ordered items.

2. The system of claim 1 including means for conveying to said party said digital assets which are stored in said central repository and which correspond to said items ordered by said party.

3. The system of claim 1 wherein each of said digital assets is developed as an original version and when said original version is updated, said original version is no longer accessible by said party.

4. The system of claim 1 wherein said digital asset is an image file.

5. The system of claim 4 wherein said image file is a graphic image.

6. The system of claim 1 further including collecting and storing each inquiry made by said party when they obtained access to said central repository and retaining such inquiries for future auditing.

7. The system of claim 1 wherein each digital asset acquired by said ordering party can be archive and linked to information that corresponds to new products that may be marketed.

8. The system of claim 1 wherein said ordering party can receive a receipt verifying exactly which digital files have been accessed or received.

9. The system of claim 1 wherein said digital asset is a photo file.

10. A system for managing digital assets comprising:
a. a first source capable of creating a designated stock code for an item;
b. a second source capable of developing a digital asset for each of said items;
c. a central repository capable of receiving, storing and disseminating said designated stock codes and said corresponding digital asset for each of said items;
d. a third source capable of identifying items ordered by a party and matching said items to at least one of said corresponding digital assets; and
e. means for conveying to said party said digital assets which are stored in said central repository and which correspond to said items ordered by said party.

11. The system of claim 10 wherein said digital assets are electronically conveyed to said party.

12. The system of claim 11 wherein said digital assets are converted into a format which is compatible with software operated by said party.

13. The system of claim 10 wherein at least one of said items ordered by said party can be electronically cross checked against said corresponding designated stock code.

14. The system of claim 10 wherein said party can identify a second party to whom said digital assets can be routed.

15. The system of claim 10 wherein said designated stock codes and said digital assets, which correspond to said ordered items by said party, can both be routed to said party prior to a time when such information is needed by said party.

16. A system for managing digital assets comprising:
a) a first source capable of creating a designated stock code for an item;
b) a second source capable of developing a digital asset for each of said items, said digital asset including at least one file from the following types of files: a visual file, an image file, a video file, an audio file, and a text file;
c) a central repository capable of receiving, storing and disseminating said designated stock codes and said corresponding digital asset for each of said items;
d) a third source capable of identifying items ordered by a first party and matching said items to at least one of said designated stock codes and to said corresponding digital asset; and
e) means for conveying said digital assets which are stored in said central repository and which correspond to said items ordered by said first party to a second party who is identified by said first party.

17. The system of claim 16 wherein said digital assets are graphical images which can be printed on a tangible medium by said external vendor.

18. The system of claim 16 wherein a computer is used to convey said digital assets to only said second party.

19. The system of claim 16 wherein said digital assets are conveyed to both said first and second parties and said digital assets are stored in a format which is readable by software utilized by said first and second parties.

20. The system of claim 16 wherein said first party can directly acquire said digital assets which are stored in said central repository and which correspond to said ordered items.

21. A system for managing digital assets comprising:
a) a first source capable of creating a designated stock code for an item;
b) a second source capable of developing a digital asset for each of said items;
c) a central repository capable of receiving, storing and disseminating said designated stock codes and said corresponding digital assets for each of said items;
d) conveying said designated stock codes and said digital files to an independent exchange;
e) said independent exchange capable of identifying items ordered by a party and matching said items to at least one of said corresponding digital assets; and
f) means for allowing said party access to said independent exchange such that said party can acquire said digital assets which correspond to said ordered items.

22. The system of claim 21 wherein said party can access said independent exchange only by entering an appropriate password.
